(19) United States
(12) Patent Application Publication
(10) Pub. No.: US 2015/0015914 A1
(43) Pub. Date: Jan. 15, 2015

(54) PRINTING APPARATUS, PRINTING METHOD, IMAGE PROCESSING APPARATUS, AND PROGRAM

(71) Applicant: SEIKO EPSON CORPORATION, Tokyo (JP)

(72) Inventor: Toshiaki KAKUTANI, Shiojiri (JP)

(21) Appl. No.: 14/325,712

(22) Filed: Jul. 8, 2014

(30) Foreign Application Priority Data
Jul. 12, 2013 (JP) 2013-146085

(51) Int. Cl. G06K 15/02

(52) U.S. Cl. CPC G06K 15/1878
USPC 358/3.01

(57) ABSTRACT

A printing apparatus includes an input unit, a color converting section, a head, a gradation number converting processing section, a printing section, and a gradation number converting processing section. The gradation number converting processing section converts the ink amount data into an expected value for forming each of the dots for each of the inks with the hues and generates dot data which represents whether or not each of the dots is formed for each of the pixels based on the expected value. The gradation number converting processing section includes a dot converting section configured to perform converting, where the expected value for forming of dots in the plurality of types is determined from the ink amount data, according to the color image data in at least a portion of the color image data for at least one of the inks with the hues.

### CROSS-REFERENCE TO RELATED APPLICATIONS

This application claims priority to Japanese Patent Application No. 2013-146085 filed on Jul. 12, 2013. The entire disclosure of Japanese Patent Application No. 2013-146085 is hereby incorporated herein by reference.

### BACKGROUND

1. Technical Field

The present invention relates to a technique for printing an image by forming dots of ink with a plurality of hues on a print medium.

2. Related Art

In recent years, it has become possible for dots in a plurality of types where the concentrations per unit of area are different to be formed for each color of ink in printers such as ink jet printers where color printing is possible. For example, it is possible to form dots with different concentrations on a print medium for certain ink colors when large and small ink droplets or large, medium, and small ink droplets are discharged, when two or more types of ink droplets with the same hue and different concentrations are discharged, or when differentiating the number of times the same ink droplets are discharged at the same or nearby positions.

Forming of dots in a plurality of types where the concentrations are different per unit of area in this manner is typically performed using a series of processes such as i) color converting from color image data to ink amount data, ii) converting to expected values of dots in a plurality of types, and iii) halftone processing. The color converting is color converting the color image data into the ink amount data for ink colors which are discharged by a head for printing. Taking large, medium, and small dots as examples of dots in a plurality of types, the ink amount data for each of the ink colors which are obtained by the color converting is converted into the expected value data for each of the large, medium, and small dots by referring to a one dimensional table. Generating and arranging of the final large, medium, and small dots are determined by performing a halftone process with regard to the expected value data which is obtained in this manner (refer to Japanese Patent No. 3926928). Here, the dots in a plurality of types may be large and small dots or may also be dots with various sizes. Alternatively, the dots in a plurality of types may be dots formed of light and dark inks or the like.

A printing method where dots in a plurality of types are formed is superior in terms of it being possible to improve graininess and form a high-quality image by using dots (for example, small dots) with a low concentration per unit of area, but there is scope for improvement in the point of how to appropriately perform mixing with dots (for example, large dots) with a high concentration per unit of area. For example, when only small dots are used, there are times when irregularities in the image, which are caused by cockling, or white streaks, which are referred to as banding and which are caused by deviation in the landing positions of each nozzle, stand out at a predetermined concentration or more. As a result, inks with a high concentration per unit of area such as medium dots or large dots are mixed from a region with a gradation value which is lower than the maximum gradation value at which it is possible to realize only small dots.

However, the use of large and small dots deteriorates graininess. In other words, graininess is improved when the ratio of using small dots increases but it is easy for problems such as irregularities which are caused by cockling or banding to occur, and it is difficult for the problems such as irregularities or banding to occur when the ratio of using large and medium dots increases in a low gradation area but graininess is deteriorated. Methods for solving the trade off in the problems, which accompany the use of large, medium, and small dots in this manner, have been found.

In addition, reducing the size, reducing the costs, saving resources, increasing the ease of manufacturing, improving the usability, and the like are desirable in the printing apparatuses in the prior art.

### SUMMARY

The present invention is created in order to solve at least some of the problems described above and it is possible to realize the present invention as the following aspects.

As a first aspect of the invention, there is provided a printing apparatus configured to print an image by forming dots of ink with a plurality of hues on a print medium. The printing apparatus comprises an input unit configured to input color image data for each of pixels which configures the image, a color converting section configured to convert colors of the color image data which has been input into ink amount data on the plurality of hues for each of the pixels, a head configured to form dots in a plurality of types for at least one of inks with hues out of the plurality of hues, a gradation number converting processing section configured to convert the ink amount data which has been set into an expected value for forming each of the dots for each of the inks with the hues and generate dot data which represents whether or not each of the dots is formed for each of the pixels based on the expected value which has been converted, and a printing section configured to drive the head in accordance with the dot data which has been generated and perform printing by forming the dots on the print medium. Here, the gradation number converting processing section may include a dot converting section configured to perform converting, where the expected value for forming of dots in the plurality of types is determined from the ink amount data, according to the color image data in at least a portion of the color image data for at least one of the inks with the hues to form dots in the plurality of types.

It is possible for the printing apparatus to form a plurality of dots according to the color image data since the converting, where the expected value for forming of dots in the plurality of types is determined from the ink amount data, is performed according to the color image data in at least a portion of the color image data for at least one of the inks with a hue where it is possible to form dots in the plurality of types.

In the printing apparatus, the dot converting section may perform selecting of a conversion parameter based on the color image data and perform the converting using the conversion parameter which has been selected. In the printing apparatus, it is possible to easily switch the types of dots which are formed according to the color image data by switching the conversion parameters.

In the printing apparatus, the color image data may be expressed as RGB data which is digital data in an RGB format or as CMYK data which is digital data in a CMYK format, and the dot converting section may perform the selecting according to a combination of the RGB data or a combination of the CMYK data. In the printing apparatus, it is sufficient if the selecting of the type of dots corresponds with the combination of the RGB data or the combination of the CMYK data, and it is possible to easily perform the selecting of the type of dots.

In the printing apparatus, the conversion parameter may be prepared as a conversion table, and the dot converting section may perform selecting of the conversion tables based on the color image data and perform the converting using the conversion table which has been selected. In the printing apparatus, it is possible to realize the converting from the color image data into the dots in a plurality of types with a high degree of freedom by referencing the converting of the dots which is held in the form of conversion tables. This is because it is possible to easily generate dots in a plurality of types based on the color image data simply by preparing the conversion tables.

In the printing apparatus, the conversion parameter may be assigned to at least a portion of grid points in an N (where N is an integer of two or more) dimensional look up table where points, where gradation values of N colors which configure the color image data are appropriately combined, are set as the grid points, and the dot converting section may perform the converting by acquiring the conversion parameter which has been assigned to the grid points which correspond to the color image data during converting of dots.

Since a plurality of conversion parameters are assigned to at least a portion of grid points in an N (where N is an integer of two or more) dimensional look up table where points, where gradation values of N colors which configure the color image data are appropriately combined, are set as the grid points, it is possible for the printing apparatus to easily extract the conversion parameters which are assigned to the grid points and it is possible to appropriately set the dots in a plurality of types for the color image data for N colors.

In the printing apparatus, the dot converting section may perform the converting using a default conversion parameter for grid points where the conversion parameters has not been assigned. By doing this, a simple configuration is possible without it being necessary to prepare conversion parameters for all of the grid points.

In the printing apparatus, the ink amount data on the plurality of hues may be assigned to each of the grid points in the N dimensional look up table, and the color converting section may perform the converting of colors by referring to the grid points according to the color image data during the converting of colors. It is possible for the printing apparatus to acquire the ink amount data in accordance with when the conversion parameters which determine the type of dots are acquired and it is also possible to complete the converting of colors at one time.

In the printing apparatus, the dot converting section may perform the converting by stochastically selecting any one of grid points in a vicinity of the color image data during the converting of dots and acquiring the conversion parameter when the color image data is a value between the plurality of grid points. It is possible for the printing apparatus to suppress deterioration in image quality without continuously selecting the same conversion parameters since the selecting of the grid points is performed stochastically.

In the printing apparatus, the conversion parameter may include information about whether the conversion parameter is to be applied to any of the inks with the plurality of hues.

In the printing apparatus, the inks with the plurality of hues may include inks of cyan, magenta, and yellow, and the dot converting section may perform the converting for any of the inks of cyan, magenta, or yellow.

In the printing apparatus, it is possible to use dots where concentrations per unit of area on the print medium are different, for example, light and dark dots with different concentrations of ink, dots with different sizes (large and small dots, large, medium, and small dots, or the like), or the like as the dots in the plurality of types. In addition, the range of the gradation values according to the dots of ink may be further widened by a combination of the above.

As a second aspect of the invention, there is provided a method for printing an image by forming dots of inks with a plurality of hues on a print medium using a head which is configured to form dots in a plurality of types for at least one of the inks with the hues out of the inks with the hues. The method in the printing apparatus includes inputting color image data for each of pixels which configures the image, converting colors of the color image data which has been input into ink amount data on the plurality of hues for each of the pixels, performing converting, where an expected value for forming each of the dots is determined from the ink amount data, according to the color image data in at least a portion of the color image data for at least one ink with a hue to form dots in the plurality of types when a halftone process, where dot data which represents whether or not dots are formed for each pixel is generated based on the ink amount data, is performed for each of the inks with the hues, generating dot data which represents whether or not the dots in the plurality of types are formed based on the expected value which has been converted, and forming the dots on the print medium by driving the head in accordance with the dot data which has been generated.

According to the printing method, it is possible to form dots in types according to the color image data since converting the ink amount data into an expected value for forming each of the dots is performed according to the color image data in at least a portion of the color image data for at least one ink with a hue where it is possible to form the dots in the plurality of types.

As a third aspect of the invention, there is provided an image processing apparatus configured to process an image in order to form dots of ink with a plurality of hues on a print medium. The image processing apparatus includes an input unit configured to input color image data for each of pixels which configures the image, a color converting section configured to convert colors of the color image data which has been input into ink amount data on the plurality of hues for each of the pixels, and a dot data generating section configured to convert the ink amount data which has been set to an expected value for forming each of the dots for each of inks with the hues, and generate dot data for dots in a plurality of types for ink with at least one hue out of the plurality of hues where the dot data represents whether or not each of the dots is formed for each of the pixels based on the expected value which has been converted. Here, the dot data generating section may include a dot converting section configured to perform converting, where the expected value for forming of dots in the plurality of types is determined from the ink amount data, according to the color image data in at least a portion of the color image data for at least one of the inks with a hue to form dots in the plurality of types.

According to the image processing apparatus, it is possible to generate dot data which includes dots of types which are to be generated according to the color image data since converting the ink amount data to the expected value for forming each of the dots is performed according to the color image data in at least a portion of the color image data for at least one of the inks with a hue where it is possible to form dots in the plurality of types.

As a fourth aspect of the invention, there is provided a program which uses a computer to realize a method where an image is printed by controlling a head which is configured to form dots in a plurality of types and forming dots of ink with a plurality of hues on a print medium for at least one of inks with hues out of a plurality of inks with hues. The program uses a computer to realize the functions of inputting color image data for each of pixels which configures the image, converting colors of the color image data which has been input into ink amount data in the plurality of hues for each pixel, performing converting, where an expected value for forming each of the dots is determined from the ink amount data, according to the color image data in at least a portion of the color image data for at least one ink with a hue to form dots of the plurality of types when a dot data generating process, where dot data which represents whether or not dots are formed for each pixel is generated based on the ink amount data, is performed for each of the inks with the hues, generating dot data which represents whether or not the dots in the plurality of types are formed based on the expected value which has been converted, and forming the dots on the print medium by driving the head in accordance with the dot data which has been generated.

According to the program, it is possible to form dots in types according to the color image data since converting the ink amount data to expected values for forming each of the dots is performed according to the color image data in at least a portion of the color image data for at least one ink with a hue where it is possible to form the dots in the plurality of types.

Not all of the plurality of constituent components of each of the aspects of the invention described above are essential, and it is possible to change, remove, or replace some of the constituent components of the plurality of constituent components with new and different constituent components, or remove some of the limited content of the constituent components of the plurality of constituent components as appropriate in order to solve some or all of the problems described above or in order to achieve some or all of the effects which are described in the present specification. In addition, in order to solve some or all of the problems described above or in order to achieve some or all of the effects which are described in the present specification, it is possible for some or all of the technical characteristics which are included in one aspect of the invention described above to be an independent aspect of the invention by being combined with some or all of the technical characteristics which are included in other aspects of the invention described above.

It is also possible for the invention to be realized in various aspects other than an apparatus. For example, it is possible to realize a method for manufacturing a printing apparatus or an image processing apparatus or a method for controlling a printing apparatus in a format such as a computer program for realizing the control method, or a permanent recording medium where the computer program is recorded.

### BRIEF DESCRIPTION OF THE DRAWINGS

Referring now to the attached drawings which form a part of this original disclosure:

FIG. 1 is a schematic configuration diagram of a printing apparatus 10 which is an embodiment;

FIG. 2 is a schematic configuration diagram of a printer 22;

FIG. 3 is a schematic configuration diagram of print heads 64 to 67 of the printer 22;

FIG. 4 is a flow chart illustrating an image printing process routine in a first embodiment;

FIG. 5 is an explanatory diagram illustrating a concept of a 3D-LUT;

FIG. 6 is an explanatory diagram illustrating a portion of data which is assigned to each grid point in a 3D-LUT which is used in the first embodiment;

FIG. 7 is a graph illustrating a relationship between ink amount data and dot expected values in a 0th large, medium, and small table;

FIG. 8 is a graph illustrating a relationship between ink amount data and dot expected values in a 3rd large, medium, and small table;

FIG. 9 is a graph illustrating a relationship between ink amount data and dot expected values in a 7th large, medium, and small table;

FIG. 10 is a flow chart illustrating a color, dot, and gradation number converting process in a second embodiment;

FIG. 11 is an explanatory diagram which describes a principle of interpolation calculating using a tetrahedron in the second embodiment;

FIG. 12 is an explanatory diagram illustrating a portion of data which is assigned to each grid point of a 3D-LUT which is used in the second embodiment;

FIG. 13 is a flow chart illustrating a color, dot, and gradation number converting process in a third embodiment; and

FIG. 14 is an explanatory diagram which exemplifies a portion of data where large, medium, and small tables for each ink color are assigned to each grid point of a 3D-LUT.

### DETAILED DESCRIPTION OF EXEMPLARY EMBODIMENTS

Below, embodiments of the present invention will be described.

### First Embodiment

### Configuration of Apparatus

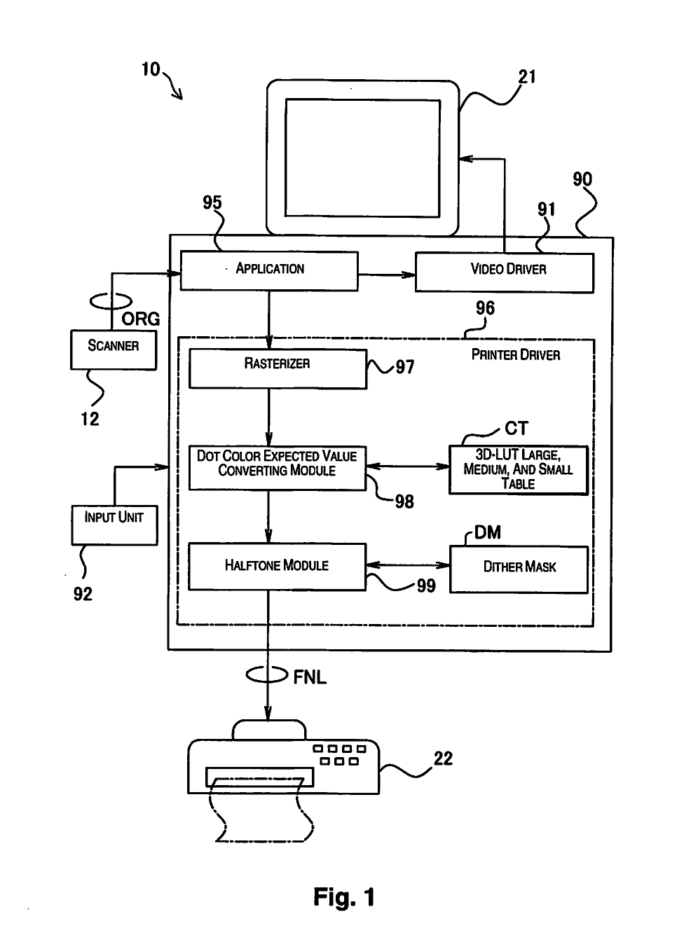

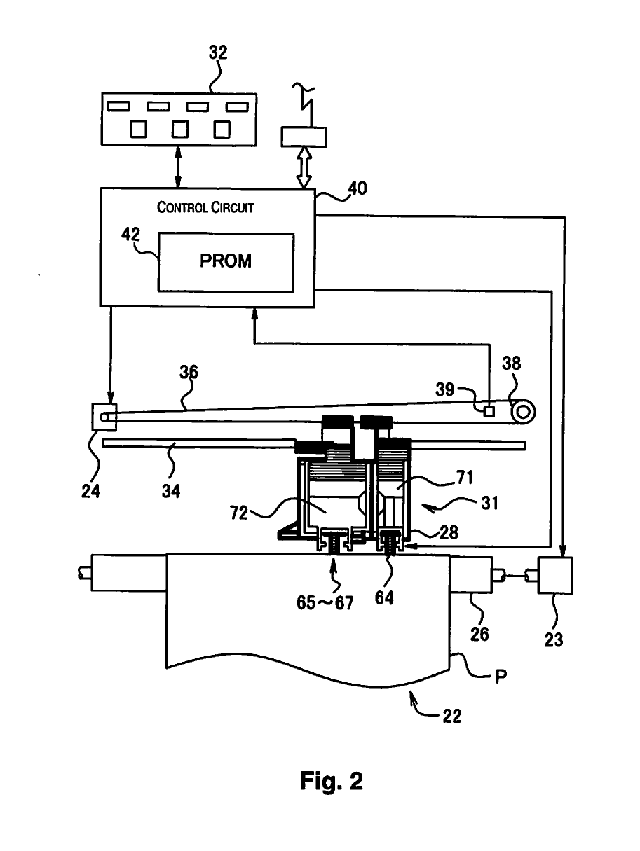

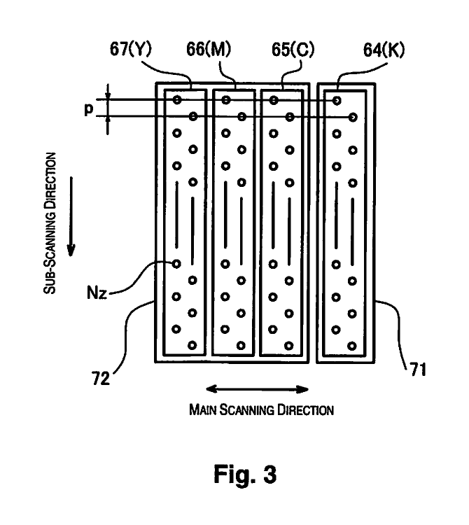

FIG. 1 is a schematic configuration diagram illustrating a configuration of a printing apparatus 10 as a first embodiment and FIG. 2 is a schematic structure of a printer 22 which is used in the printing apparatus 10. The printing apparatus 10 of the present embodiment is configured from a personal computer 90 and the color printer 22. The personal computer 90 is provided with an input unit 92 which is formed from a color display 21, a keyboard, a mouse, or the like. In addition, the personal computer 90 is connected with a scanner 12. The scanner 12 reads color image data from a color original and supplies original color image data ORG, which is formed from color components of the three colors of red (R), green (G), and blue (B), to the computer 90.

A known CPU, RAM, ROM, and the like which are not shown in the diagram are provided inside the computer 90 and an application program 95 is operated in a predetermined operating system. A video driver 91 and a printer driver 96 are incorporated into the operating system, and dot data FNL for forming the color image data is output from the application program 95 to the printer 22 via these drivers. The application program 95 which performs retouching of images and the like reads the image from the scanner 12 and displays the image on the CRT display 21 via the video driver 91 while performing a predetermined process with regard to the image.

When the application program 95 issues a print command, the printer driver 96 of the computer 90 receives image information from the application program 95 and converts the image information into a signal FNL (here, a signal which corresponds to dot data which has multiple values for the four colors of cyan, magenta, yellow, and black) which the printer 22 is able to print. In the example shown in FIG. 1, a rasterizer 97 which converts the color image data which is held by the application program 95 into image data in dot units (referred to below as pixels), a color and dot expected value converting module 98 which sets expectations for ink discharge amounts for each color in consideration of the ink colors which are used by the printer 22 and the characteristics or the like of the color development with regard to the image data in dot units, and a halftone module 99 which performs gradation number converting are provided inside the printer driver 96. In addition, a 3D-LUT and large, medium, and small tables CT, which are referred to by the color and dot expected value converting module 98, and a dither mask DM, which is referred to by the halftone module 99, are also stored inside the printer driver 96.

The signal FNL which is processed by the printer driver 96 is received and the printer 22 records the image information on a recording sheet P. The schematic configuration of the printer 22 will be described based on FIG. 2. As shown in the diagram, the printer 22 is configured from a mechanism which transports the sheet P using a sheet feeding motor 23, a mechanism which moves a carriage 31 back and forth in the axial direction of a platen 26 using a carriage motor 24, a mechanism which controls discharging of ink and forming of dots by driving a print head 28 which is mounted on the carriage 31, and a control circuit 40 which governs exchanging of signals between the sheet feeding motor 23, the carriage motor 24, the print head 28, and the operation panel 32.

It is possible to mount a cartridge 71 for black ink (Bk) and cartridges 72 for color inks which accommodate inks of the three colors of cyan (Cl), magenta (Ml), and yellow (Y) in the carriage 31 of the printer 22. The two colors of cyan and magenta may be provided with inks in two types which are light and dark. A total of four ink discharging heads 64 to 67 are formed in the print head 28 in the lower section of the carriage 31 and inlet pipes which lead ink from ink tanks into the heads of each of the colors are installed in the bottom section of the carriage 31. When the cartridge 71 for black ink (Bk) and the cartridges 72 for color inks are mounted into the carriage 31 from above, the inlet pipes are inserted into connecting holes which are provided in each of the cartridges and it is possible to supply inks from each of the ink cartridges to the discharging heads 64 to 67.

32 nozzles Nz are provided for each of the colors in the heads 64 to 67 for each of the colors, and piezo elements with superior responsiveness which are electrostrictive elements are arranged in each of the nozzles. By applying electrical signals from the control circuit 40 to the piezo elements, the piezo elements contract and the ink which corresponds to the portions which contract is discharged at high speed as ink droplets from the front ends of the nozzles Nz. Printing is performed by the ink droplets being soaked into the sheet P which is mounted on the platen 26. Movement of the meniscus (interface) of the nozzle Nz is controlled by controlling the polarity (positive or negative) and the inclining of the voltage which is applied to the piezo element in the printer 22 of the present embodiment, and it is possible to discharge large, medium, and small ink droplets. In other words, it is possible for the printer 22 of the present embodiment to form dots in three types with different amounts of ink per unit of area for each of the colors. In the present embodiment, each of the ink droplets is adjusted such that the small dots have a volume of 2 pl, the medium dots have a volume of 6 pl, and the large dots have a volume of 10 pl. When dots are formed in a circular shape by the ink droplets landing on the sheet P, dots are formed with dot diameters in three types which are large, medium, and small. Below, with this meaning, “dots with different amounts of ink per unit of area” and “dots with different dot diameters” are used with the same meaning. Since controlling the size of ink droplets in this manner is well known, detailed description will be omitted. Here, in order to form the dots with different dot diameters, there may be a configuration where dedicated nozzles which discharge large, medium, and small ink droplets are provided.

The printer 22 which has the hardware structure described above performs discharging of each of the color inks and forms an image of multiple colors by forming dots on the sheet P by driving the piezo elements of each of the color heads 64 to 67 of the print head 28 at the same time as moving the carriage 31 back and forth (referred to below as main scanning) using the carriage motor 24 while transporting (referred to below as sub-scanning) the sheet P on the platen 26 by rotating another roller using the sheet feeding motor 23.

The mechanism which transports the sheet P is provided with a gear train (which is not shown in the diagram) which transmits rotation of the sheet feeding motor 23 to a sheet transporting roller in addition to the platen 26. In addition, the mechanism which moves the carriage 31 back and forth is configured by a sliding shaft 34 which extends in parallel with the axis of the platen 26 and which holds the carriage 31 so as to be able to slide, a pulley 38 which is provided to stretch an endless driving belt 36 between the pulley 38 and the carriage motor 24, a position detecting sensor 39 which detects the home position of the carriage 31, and the like.

### Image Printing Process Routine

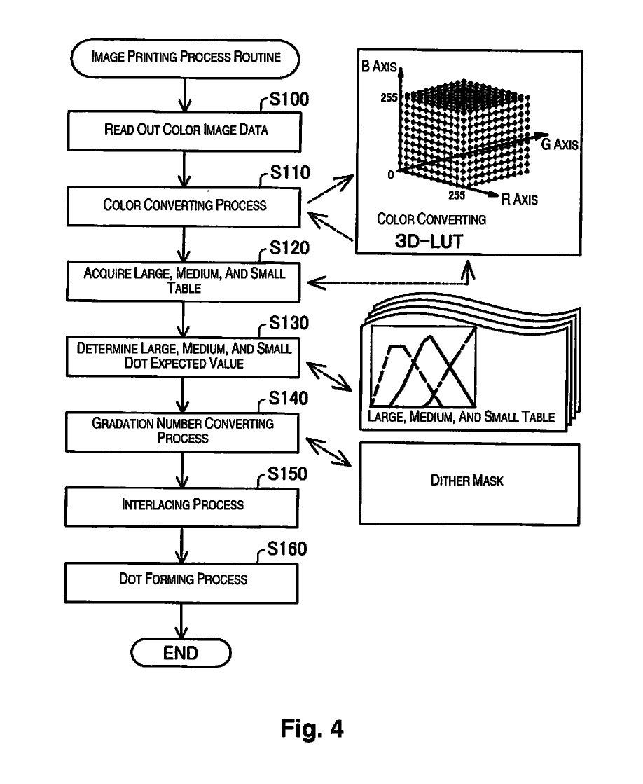

Next, a printing process will be described which is executed in the first embodiment where the hardware configuration described above is provided. FIG. 4 is a flow chart illustrating a flow of an image printing process routine according to the first embodiment. The routine is a portion of processing of the color and dot expected value converting module 98 and the halftone module 99 of the printer driver 96 and is a routine which is executed by the CPU of the computer 90 in the present embodiment. Here, in the present specification, “halftone” has the meaning of a process of converting (reducing) the number of gradations which are included in a multi-value process such as ON/OFF or the like of large dots and small dots without being limited to a binarization process which is ON/OFF of dots.

The process routine starts after an instruction to print is given from the application program and the rasterizer 97 of the printer driver 96 receives the data for printing from the application program, the data for printing is rasterized, and the data for printing is converted into data which expresses an image as a set of a plurality of pixels. When the image printing process routine is started, a process of reading the color image data ORG which is rasterized is executed first (step S100). As has already been described, the color image data ORG is data in an RGB format. Here, each color of RGB is expressed using 8 bit digital data.

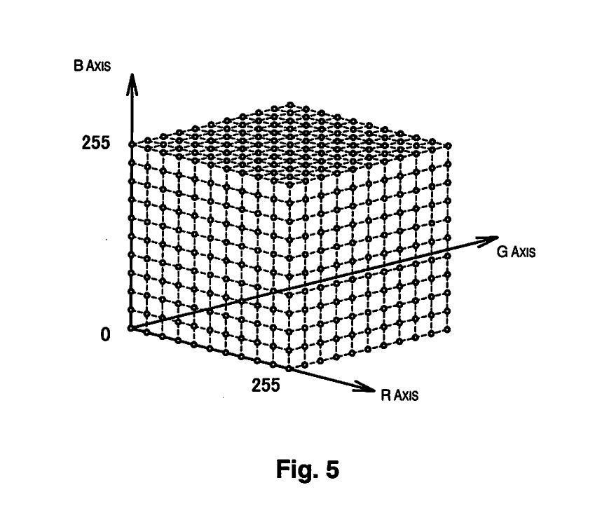

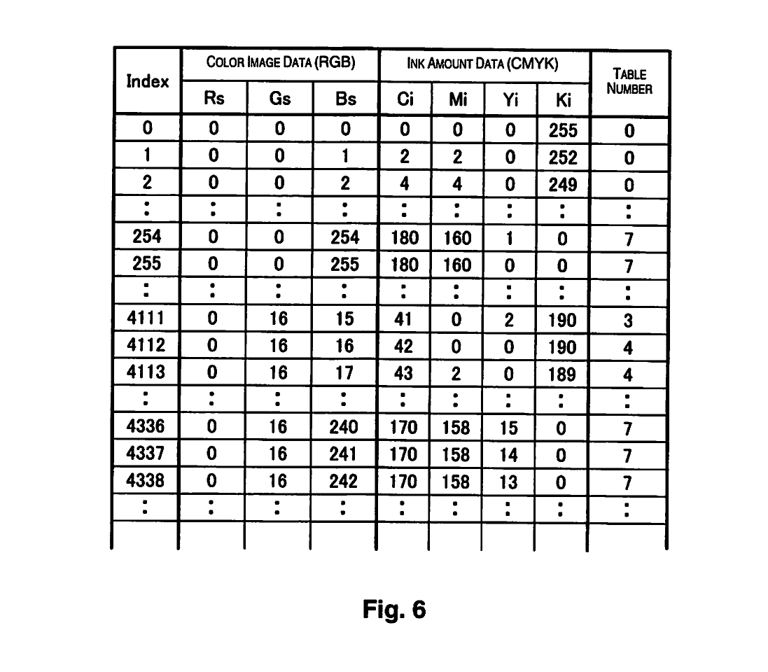

When the original color image data ORG is read out, the color converting process is executed next (step S110). The color converting process is performed by referring to a 3D-LUT (a three-dimensional look up table) for color converting. The image in the 3D-LUT is shown in FIG. 5. In addition, a portion of the specific content of the 3D-LUT which is used in the first embodiment is shown in FIG. 6. Since each of RGB which configure the color image data are expressed as 8 bits of data, it follows that there are 256×256×256 combinations of RGB. When the combinations (Rs, Gs, and Bs) of the data are regarded as grid points, it is possible to easily perform color converting by referring to the 3D-LUT when the data (Ci, Mi, Yi, and Ki) of each of the corresponding ink colors corresponds to each of the grid points.

As shown in FIG. 6, data (Ci, Mi, Yi, and Ki) of each of the ink colors is prepared in the first embodiment for all of the 256×256×256 grid points to match the 8 bits of image data. In addition, large, medium, and small table numbers are assigned with regard to each piece of the RGB data. These table numbers are used in the processes of step S120 and beyond.

After the color converting process, a process of acquiring the large, medium, and small table numbers is performed (step S120). This process is a process of acquiring the table numbers from the 3D-LUT shown in FIG. 6. Accordingly, the process is performed in practice at the same time as the color converting process in step SI 10. In the present embodiment, there are 8 table numbers from 0 to 7. Accordingly, it is possible to record the table numbers in the 3D-LUT as 3 bits of data. Here, when there are two or more types of table, the table number may be increased or reduced.

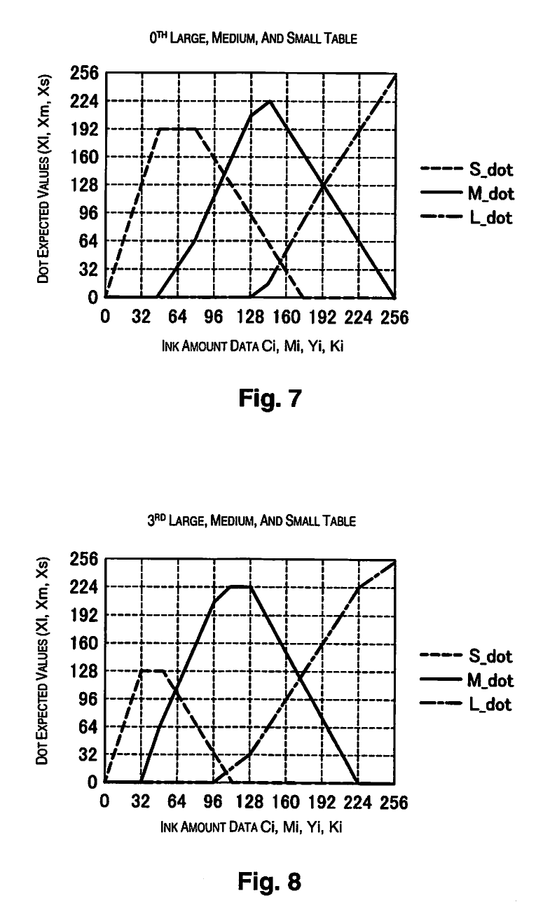

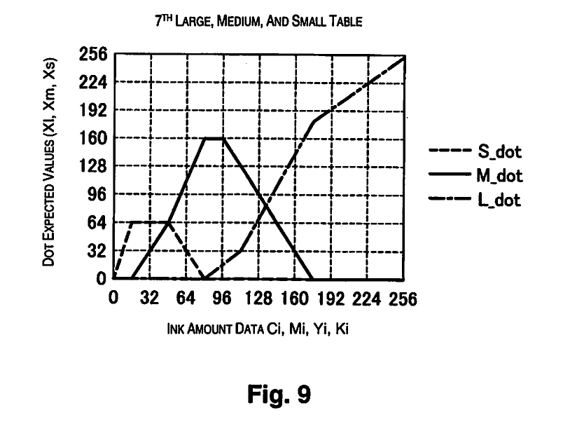

The table number which is acquired in step S120 shows the type of table where the expected values of the large, medium, and small dots are set. The dot expected values are values which indicate in what ratio each of small dots, medium dots, or large dots are formed with regard to predetermined ink amount data. The dot expected value is 100% in a case where the dots are formed in all of the pixels on the sheet P, that is, the dot expected value corresponds to 256 in a case of being represented by 8 bits of data. FIG. 7 to FIG. 9 show graphs illustrating the relationship between the ink amount data and the dot expected values. FIG. 7 is a graph illustrating the relationship between the ink amount data and the dot expected values in a case where the table number is 0. In the same manner, FIG. 8 shows a case where the table number is 3 and FIG. 9 shows a case where the table number is 7. S_dot indicates the expected value of the small dots, M_dot indicates the expected value of the medium dots, and L_dot indicates the expected value of the large dots in the diagrams. The total of the expected values of the large, medium, and small dots which correspond to the specific ink amount data is set such that the gradation values of the original color image are reproduced in a case where each of the dots is formed at the ratios of each of the expected values.

In the present embodiment, eight types of table are prepared from table number 0 to 7. Accordingly, with regard to each of the tables shown in FIG. 7 to FIG. 9, there are tables with table numbers 1 and 2 and tables with table numbers 4, 5, and 6 respectively between table numbers 0 and 3 and 3 and 7. Table number 0 corresponds to the default table for the printer 22, and each of the tables is adjusted such that, as the table number increases from table number 0, the expected value of the small dots decreases and the expected values of the medium dots and the large dots increase. In other words, the larger the table number is, the larger the dots that are formed from regions where the amount of ink is small (low gradation regions).

A portion of the eight types of large, medium, and small tables which are prepared in the present embodiment is exemplified in FIG. 6 but the tables are assigned largely according to the following order.

(1) A table with a low number is assigned to a low gradation region and a table with a high number is assigned to a high gradation region.

(2) A high table number is assigned in a case where the total value of the amounts of ink is high.

(3) In the above, a table with a low number is assigned in a case of a high ratio of the ink colors (black, magenta, and the like) where it is easy for the dots which are formed to stand out.

Next, the printer driver 96 performs a process where the expected values of the large, medium, and small dots are determined (step S130). This process specifies the relationship of the dot expected values with relation to pixels which are targets from the ink amount data (Ci, Mi, Yi, and Ki) which is obtained by the color converting (step S110) and the table number which is acquired in step S120 and determines the expected values of each of the large, medium, and small dots using the specified relationship as a reference. For example, when the ink amount Ci of cyan ink is a value of 96 as shown in FIG. 7, the expected value of the large dots is 0, the expected value of the medium dots is 112, and the expected value of the small dots is 160. On the other hand, when the table number is 7, the expected values of each of the dots in a case where the cyan ink amount Ci is a value of 96 are 16 for the large dots, 160 for the medium dots, and 0 for the small dots. Here, the expected values of the large, medium, and small dots for each of the ink colors are represented as

cyan ink (Cl, Cm, Cs),

magenta ink (Ml, Mm, Ms),

yellow ink (Yl, Ym, Ys), and

black ink (Kl, Km, Ks).

Here, since the dot expected values are common to the four colors of cyan, magenta, yellow, and black in the first embodiment, the dot expected values are written as (Xl, Xm, and Xs) as shown in FIG. 7 to FIG. 9 in cases where the ink color is not relevant.

An example is shown where the process is performed for each of the colors in practice. When the color image data (Rs, Gs, and Bs) is (0, 16, and 240), (170, 158, 15, 0) is obtained as the ink amount data (Ci, Mi, Yi, and Ki) by referring to the 3D-LUT. At the same time, since the number 7 is assigned to the color image data as the large, medium, and small table, the expected values (Xl, Xm, and Xs) of the large, medium, and small dots are determined by referring to the 7th large, medium, and small table. In this example, the following expected values are obtained:

cyan ink (Cl, Cm, Cs)=(0, 12, 164),

magenta ink (Ml, Mm, Ms)=(0, 36, 140),

yellow ink (Yl, Ym, Ys)=(60, 0, 0), and

black ink (Kl, Km, Ks)=(0, 0, 0).

In this manner, when the ink amount data (Ci, Mi, Yi, and Ki) for each of the colors which correspond to the color image data (Rs, Gs, and Bs) and the table number are acquired by referring to the 3D-LUT and the expected values (Xl, Xm, and Xs) of each of the dots are determined, a gradation number converting process is performed next (step S140). This process corresponds to the process of the halftone module 99 and is a process where the ink amount data (8 bits and 256 gradations) of each of the colors is converted into any of large, medium, and small dots including cases where dots are not formed (4 gradations). In detail, determining of whether any of large dots, medium dots, or small dots are formed or whether none are formed is performed by comparing the expected values (Xl, Xm, and Xs) of the large, medium, and small dots of each of the color inks with halftone thresholds.

In the present embodiment, determining whether the large, medium, and small dots are formed is performed using a method such as continuous dither. Continuous dither is a method where it is determined whether or not dots are formed by comparing the threshold of a dither mask in the order of the large, medium, and small dots while adding the expected values of the large, medium, and small dots of the pixels which are the target in order. In practice, when the coordinates of the target pixel are represented by (x, y), firstly, the expected value Xl (x, y) of the large dots is compared with a threshold THd (xd, yd) of a location which corresponds to the dither mask, and when the expected value Xl (x, y) of the large dots is equal to or more than the threshold THd (xd, yd), it is determined that the large dots are formed. That is, when Xl (x, y)≧THd (xd, yd), it is determined that the large dots are ON.

On the other hand, when the expected value Xl (x, y) of the large dots is lower than the threshold THd (xd, yd), determining is then performed for the medium dots and comparing is performed with the same threshold THd (xd, yd) once the expected value Xl (x, y) of the large dots is added to the expected value Xm (x, y) of the medium dots. When the total of the expected values Xm (x, y)+Xl (x, y) is equal to or more than the threshold THd (xd, yd), it is determined that the medium dots are formed. That is, when

Xl(x,y)+Xm(x,y)≧THd(xd,yd),

it is determined that the medium dots are ON.

Furthermore, when the total of the expected values (x, y)+Xl (x, y) of the medium dots and the expected values of the large dots Xm is lower than the threshold THd (xd, yd), determining is then performed for the small dots and comparing is performed with the same threshold THd (xd, yd) once the expected values Xn (x, y)+Xl (x, y) of the large and medium dots are added to the expected value Xs (x, y) of the small dot. When the total of the expected values Xs (x, y)+Xm (x, y)+Xl (x, y) is equal to or more than the threshold THd (xd, yd), it is determined that the small dots are formed. That is, when

Xl(x,y)+Xm(x,y)+Xs(x,y)≧THd(xd,yd),

it is determined that the small dots are ON.

In this manner, when comparing of the dot expected values and the threshold is performed and it is determined that dots are not formed in the order of large, medium, and small dots, comparing is performed with the same threshold THd (x, y) of the dither mask while adding the expected value of the dots which are determined up to this point to the expected values of the dots on the smaller side. As a result, if the color image data with the same gradation values is to be printed, ON/OFF data on the large, medium, and small dots, that is, dot data is generated such that dots are formed continuously from the small threshold of the dither mask in the order of large dots to small dots.

In this manner, when determining whether the large, medium, and small dots of each of the colors are formed from the color image data ORG is completed, the printer driver 96 then performs an interlacing process where the dot data which is generated is lined up in a sequence in which each of the color heads 64 to 67 forms dots (step S150). After this, the data which is lined up is output to the printer 22 and a dot forming process is performed (step S160).

In the printing apparatus 10 of the first embodiment described above, it is possible to reproduce the color image data ORG on the sheet P using large, medium, and small dots with inks of the four colors of CMYK. At this time, the table which sets the expected values of the large, medium, and small dots is assigned in consideration of the ink amount data for each of the colors. As a result, it is possible to form large, medium, and small dots with an appropriate ratio according to the color image data ORG. For example, by setting as follows:

(1) a table with a low number is assigned to a low gradation region and a table with a high number is assigned to a high gradation region,

(2) a high table number is assigned in a case where the total value of the amounts of ink is high, and

(3) in the above, a table with a small number is assigned in a case where the ratio of the ink colors (black, magenta, and the like) where it is easy for the dots which are formed to stand out,

it is possible to suppress generating of irregularities by increasing the large and medium dots in a case where it is easy for cockling to be generated by increasing the amounts of ink in addition to improving graininess by increasing the ratio of the small dots in the low gradation regions. In other words, it is possible to eliminate the problem of conflict between suppressing generating of banding and irregularities and improving graininess by switching the table of the dot expected values according to the ink amount data.

In addition, since eight types of tables are prepared in the present embodiment, it is possible to gradually perform switching of the large, medium, and small tables in this manner and it is possible to suppress deterioration of image quality which accompanies switching of the tables.

### Second Embodiment

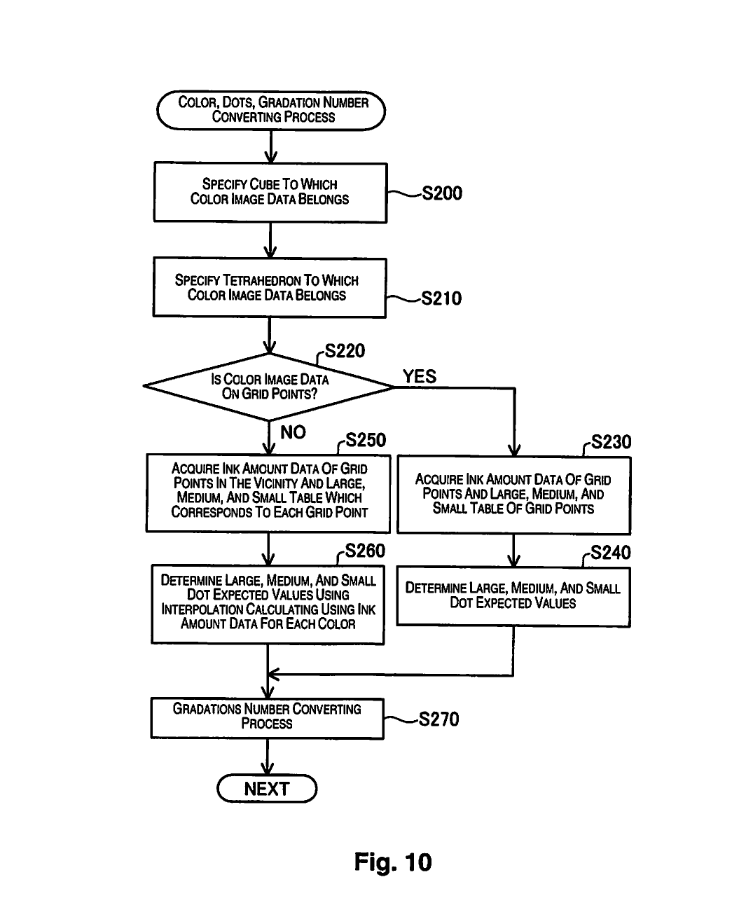

Next, a second embodiment of the invention will be described. The printing apparatus 10 of the second embodiment has the same hardware configuration as the first embodiment. In the present embodiment, only the processes which correspond to the processes of the color and dot converting module 98 and the halftone module 99 of the printer driver 96 are different. The processes of this portion in the second embodiment are shown in FIG. 10 as a color, dot, and gradation number converting process. This process corresponds to steps S110 to S160 in FIG. 4 of the first embodiment. In addition, in the second embodiment, the 3D-LUT is different to the first embodiment and grid points are used for each of 17 colors.

The color and dot converting module 98 which receives the color image data ORG from the rasterizer 97 performs a process where a cube of the grid points which belong to the color image data is specified by referring to the 3D-LUT for color converting (step S200). After this, it is further specified to which of the tetrahedrons the color image data belongs in the cube (step S210). These processes will be described.

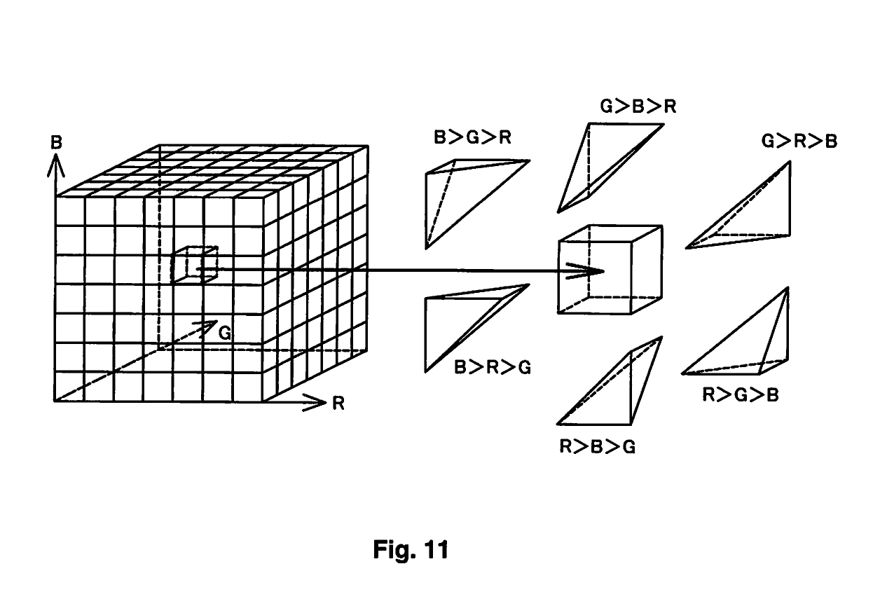

As described above, since there are only 17 grid points for each of the colors in the 3D-LUT in the second embodiment, there are cases where it is not possible to directly read out the ink amount data for each of the color inks from the corresponding grid points when certain color image data ORG is given. Then, in the second embodiment, it is firstly specified to which of the cubes in the 3D-LUT the color image data (Rs, Gs, and Bs) of the pixels which are the target belong to as shown in FIG. 11. The cubes are virtual shapes which are formed of eight grid points which encompass the color image data (Rs, Gs, and Bs).

Next, it is specified to which of the six of the tetrahedrons when the cube is divided up are the color image data (Rs, Gs, and Bs) belongs. When focusing on one of the cubes, the RGB data is respectively assigned to the eight grid points which configure the cube, and it is understood that there are six magnitude relationships of R, G, and B. The six tetrahedrons correspond to the magnitude relationships of the RGB data. In this manner, since it is possible to color convert specific color image data which is exists inside a cube by comparatively simple interpolation if it is possible to specify to which of the tetrahedrons the color image data (Rs, Gs, and Bs) belongs, it is specified to which of the tetrahedrons the color image data (Rs, Gs, and Bs) belongs in preparation for processing which follows.

When the processes of step S200 and S210 are complete, determining of whether or not the color image data (Rs, Gs, and Bs) exist on the grid points is performed next (step S220). When the color image data (Rs, Gs, and Bs) is on the grid points, the ink amount data (Ci, Mi, Yi, and Ki) which is assigned to the grid points and the large, medium, and small tables are acquired (step S230). Acquiring of the large, medium, and small tables is performed by reading the table numbers which are assigned to the grid points of the 3D-LUT in the same manner as the first embodiment.

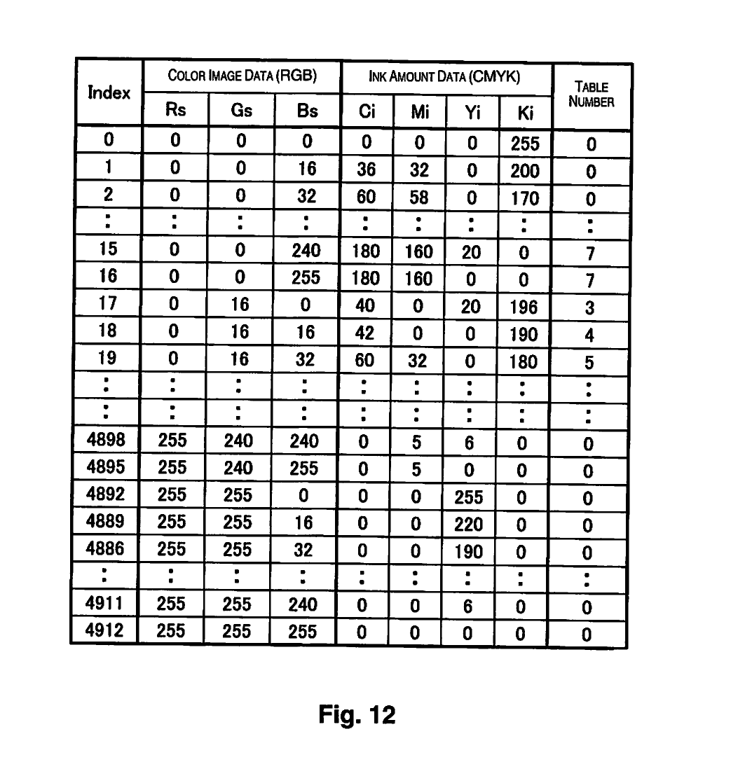

A portion of the 3D-LUT which is used in the second embodiment is shown in FIG. 12. The 3D-LUT which is used in the second embodiment is divided into 17 gradations for each of the colors of RGB as is clear from the diagram. The intervals of division are for every 16 gradations for each of Rs, Gs, and Bs such as 0, 16, 32, . . . , 240, and 255, except for between 240 and 255 which is at the end and has 15 gradations. Since each of the colors is divided into 17 gradations, the number of grid points is 17×17×17=4913. The serial number “Index” of these grid points is 0 to 4912. The numbers (0 to 7) of the large, medium, and small tables are also recorded in each of the grid points. When the color image data (Rs, Gs, and BS) is on the grid points, it is possible to acquire the ink amount data (Ci, Mi, Yi, and Ki) and the table numbers by referring to the 3D-LUT shown in FIG. 12. After obtaining these pieces of data, the respective expected values of the large, medium, and small dots are determined in the same manner as the first embodiment (step S240).

On the other hand, in a case where it is determined that the color image data is not on the grid points (step S220), the ink amount data (Ci, Mi, Yi, and Ki) which is assigned to the surrounding grid points and the large, medium, and small tables which correspond to each of the grid points are acquired (step S250). Then, the expected values of the large, medium, and small dots which correspond to each of the grid points are determined by referring to the ink amount data and the large, medium, and small tables and the expected values of the large, medium, and small dots are determined using a tetrahedral interpolation method (step S260). Since the method of interpolation using tetrahedrons is described in detail in Japanese Unexamined Patent Application Publication No. 11-191848 and the like, detailed description of the method will be omitted, but as a simple description, the following procedure is performed.

(A) The ink amount data (Ci, Mi, Yi, and Ki) of four of the grid points which configure the tetrahedron, to which the color image data (Rs, Gs, and Bs) belongs, is acquired.

(B) At the same time, the large, medium, and small tables which are specified by each of the grid points are acquired.

(C) The expected values of each of the dots of each of the color inks are determined by applying each of the large, medium, and small tables to the ink amount data (Ci, Mi, Yi, and Ki) of the four of the grid points.

(D) Interpolation calculating of the tetrahedron is carried out with regard to each of the dot expected values of each of the color inks and the expected values of the large, medium, and small dots of each of the color inks which correspond to the color image data (Rs, Gs, and Bs) are determined.

According to the process described above, it is possible to determine the expected values of each of the dots of each of the color inks even in a case where the color image data is on the grid point or even in a case where the color image data is not on the grid point. Then, after the processes of step S240 or step S260, the gradation number converting process (step S270) is performed in the same manner as the first embodiment. This process corresponds to the process of the halftone module 99 and determines the ON/OFF of the large, medium, and small dots of each of the colors using the concept of the continuous dither in the same manner as the first embodiment.

According to the second embodiment described above, it is possible to reduce the data content of the 3D-LUT in addition to achieving the same operational effects as the first embodiment. It is possible to make do with a data amount which is approximately equal to or less than 3/10000 compared with the first embodiment.

### Third Embodiment

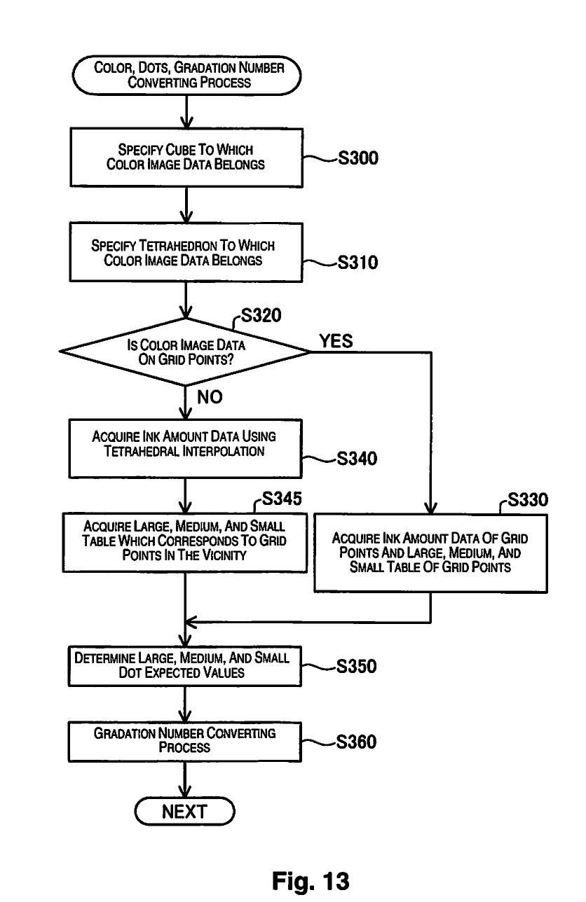

Next, a third embodiment of the invention will be described. The printing apparatus 10 of the third embodiment has the same hardware configuration as the first and second embodiments. In the present embodiment, only the processes which correspond to the processes of the color and dot converting module 98 and the halftone module 99 of the printer driver 96 are different. The processes of this portion in the third embodiment are shown in FIG. 13 as the color, dot, and gradation number converting process. This process corresponds to steps S110 to S160 in FIG. 4 of the first embodiment. In addition, in the third embodiment, a 3D-LUT with grid points for each of 17 colors is used in the same manner as the second embodiment.

The color and dots converting module 98 which receives the color image data ORG from the rasterizer 97 performs a process where a cube of the grid points to which the color image data belongs is specified (step S300) and a process where it is specified to which of the tetrahedrons the color image data belongs in the cube (step S310) by referring to the 3D-LUT for color converting in the same manner as the second embodiment.

When the processes of steps S300 and S310 are complete, determining whether or not the color image data (Rs, Gs, and Bs) exists on the grid points is then performed (step S320). When the color image data (Rs, Gs, and Bs) is on the grid points, the ink amount data (Ci, Mi, Yi, and Ki) which is assigned to the grid points and the large, medium, and small tables are acquired (step S330). Acquiring of the large, medium, and small tables is performed by reading the table numbers which are assigned to the grid points of the 3D-LUT in the same manner as the first and second embodiments.

On the other hand, in a case where it is determined that there is no color image data on the grid points (step S320), the ink amount data is acquired (step S340) according to interpolation calculating using the tetrahedron which is specified in step S310. This is because, since each piece of the ink amount data is assigned to the four of the grid points which encompass the color image data, the ink amount data (Ci, Mi, Yi, and Ki) which corresponds to the color image data is acquired according to interpolation calculating using the ink amount data on each of the grid points. This process is the same as in the second embodiment. Next, the large, medium, and small tables which correspond to the grid points which are the closest to the color image data (Rs, Gs, and Bs) are acquired (step S345). After this, the expected values of each of the dots of each of the color inks are determined in all cases using the large, medium, and small tables which are acquired (step S350). Furthermore, the gradation number converting process (step S360) is performed in the same manner as the first and second embodiments. This process corresponds to the process of the halftone module 99 and determines the ON/OFF of the large, medium, and small dots of each of the colors using the concept of the continuous dither in the same manner as the first and second embodiments.

In the third embodiment described above, the 3D-LUT only has 17 grid points for each of the colors of RGB in the same manner as the second embodiment, but interpolation calculating using the tetrahedron is applied when the ink amount data is determined from the color image data and it is sufficient to perform interpolation calculating using the tetrahedron only one time. Then, the large, medium, and small tables which are assigned to the grid points which are closest to the color image data (Rs, Gs, and Bs) are acquired out of the grid points of the surroundings in step S345. In the third embodiment, the ink amount data is determined using interpolation calculating and the large, medium, and small tables for the grid points in the vicinity are used. The large, medium, and small tables represent at what ratio each of the large, medium, and small dots are formed with regard to the amount of ink to be realized. As a result, deviation in the gradations and the like do not occur even when using the large, medium, and small tables for the grid points in the vicinity.

The large, medium, and small tables may be acquired using the following methods in addition to adopting the large, medium, and small tables which are assigned to the grid points which are the closest to the color image data.

(i) The large, medium, and small table are selected in a specific order from the grid points which encompass the color image data (Rs, Gs, and Bs).

(ii) Any one of four of the grid points which configure the tetrahedron of the surroundings or eight grid points which configure a hexahedron is selected using a random number or the like.

(iii) A grid point is selected by performing a truncation of the absolute value after adding positive and negative noise for the size of the extent of the intervals between the grid points to the color image data.

(iv) The grid points are selected using the same concept as in (i) described above, but for the grid points where processing is complete at that time, the difference between the original color image data (Rs, Gs, and Bs) and the RGB data on the grid points which are selected is determined, correction data is determined by adding the difference to the image data on the pixels to be processed next, and the closest grid points are selected from the correction data.

In these methods, since the large, medium, and small tables which are assigned to the grid points which encompass the ink amount data are used at predetermined ratios, it is possible to realize an image by the ratio of the large, medium, and small dots being in a more desirable state without using the same large, medium, and small tables even when the same color image data is continuous.

In all of the methods of (i) to (iv) described above, the large, medium, and small tables are changed with a specific probability even when the color image data is the same, and it is difficult for a phenomenon where the large, medium, and small tables are suddenly switched to occur when the color image data is being changed smoothly. Accordingly, generating of false contours in these regions is also suppressed.

### Modified Example

### Modified Example 1

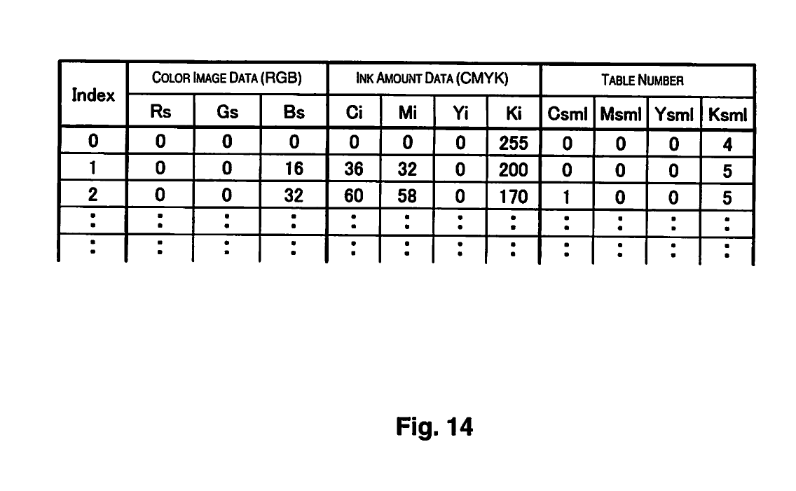

In each of the embodiments described above, the same large, medium, and small table are used for the four colors cyan, magenta, yellow, and black, but different large, medium, and small tables may be used for each of the colors. For example, large, medium, and small tables may be prepared for each of the colors such as a large, medium, and small table for cyan ink and a large, medium, and small table for magenta ink and the like may be prepared for each of the large, medium, and small tables with the table numbers of 0, 1, and the like. Alternatively, four of the large, medium, and small table numbers which correspond to each of the ink colors in the 3D-LUT may be assigned as shown in FIG. 14. In addition, switching the large, medium, and small tables based on the information in the 3D-LUT may be only for the two colors of cyan and magenta where it is easy for color irregularities to stand out and large, medium, and small tables which are fixed in advance may be used for yellow and black. Alternatively, the large, medium, and small table numbers where the number of colors is low and the information about which colors to apply to the table numbers may be combined and stored. For example, one of the large, medium, and small table numbers which are stored in the 3D-LUT is set to only one grid point, and 1 bit of information (1 means apply and 0 means do not apply) on which color to apply the large, medium, and small table to is stored as a set with the large, medium, and small table numbers in the 3D-LUT for the number of ink colors only. In a case of not being applied, it is sufficient to use the default large, medium, and small tables which are defined separately for each of the ink colors.

In this manner, if it is possible to select large, medium, and small tables which are different for each ink color, it is possible to control forming of dots which are even finer for each ink color. If there is an intention to use small dots as much as possible in order to improve graininess which stands out depending on the ink color, there are also colors which are hardly affected by graininess such as yellow ink for example. Accordingly, if it is possible to finely control the expected values of the large, medium, and small dots according to the differences in the ink colors, it is possible to contribute to improving image quality.

### Modified Example 2

In the embodiments described above, the ink colors which are able to be output by the printing apparatus 10 are the four colors of CMYK, but application is possible to a printing apparatus which is able to output light inks such as light magenta LM or light cyan LC, special colors such as orange or green, gray inks for obtaining an improved gray balance, and the like. In this case, the output from the 3D-LUT matches the number of ink colors which are able to be output and may be set to, for example, five colors or more. In addition, the color image data is not limited to RGB and may be input as CMYK which is widely used in printing applications. In this case, it is sufficient to perform four-dimensional interpolation calculating using a four-dimensional LUT. For example, instead of the three-dimensional data in FIG. 6 (Rs, Gs, and Bs) in the first embodiment, four-dimensional CMYK data with 256 gradations for each color of (Ci, Mi, Yi, and Ki) is used. In a case where the intervals of the grid points have a gradation value of 1, the number of grid points in the four-dimensional LUT is 256⁴ and the maximum value of the “Index” is 256⁴-1.

### Modified Example 3

In the embodiments described above, the numbers for the large, medium, and small tables are recorded in the 3D-LUT, but the expected values for each of the dots may be set using another method. For example, instead of the large, medium, and small table numbers, the start address in the memory where the corresponding large, medium, and small tables are stored may be recorded directly in the 3D-LUT. In addition, a configuration may be adopted where only one of the large, medium, and small tables is prepared for each of the ink colors and, for example, the largest small dot expected value and the largest medium dot expected value are recorded as large, medium, and small adjustment parameters in the 3D-LUT instead of the numbers for the large, medium, and small tables. In this case, the ink amount converting means between the dots is prepared separately. For example, the replacement ratio from the small dots to the medium dots: s2m and the replacement ratio from the medium dots to the large dots: m21 are defined in advance.

An example of this case is shown below. The replacement ratio from the small dots to the medium dots is

s2m=0.5

and the replacement ratio from the medium dots to the large dots is

m2l=0.4.

In relation to cyan C, only the 0th table of the first embodiment is used as the large, medium, and small table. When the ink amount data (Ci, Mi, Yi, and Ki) which corresponds to certain color image data (Rs, Gs, and Bs) is determined using interpolation calculating,

Ci=64.

In this case, when referring to the 0th table,

Cl=0,

Cm=32, and

Cs=192.

At this time, the maximum value of the expected values of the small dots and the maximum value of the expected values of the medium dots are determined by tetrahedral interpolation calculating from the values of four of the grid points in the vicinity which are obtained by referring to the 3D-LUT. As a result, since Cs exceeds a small dot maximum value of 64 when the small dot maximum value is 64 and the medium dot maximum value is 56, when data after converting is represented by the suffix “new”, the excess portion is represented by the suffix “over” and a provisional value is further represented by the suffix “0”,

Cs_new=64

Cs_over=Cs−64=128

The excess portion is converted to a medium dot amount and added to the medium dot expected value.

$$\begin{matrix}Cm\_new0 = Cm + Cs\_over \times s 2 m \\ = 32 + 128 \times 0.5 \\ = 96\end{matrix}$$

Since the provisional medium dot expected value: Cm_new0 exceeds the maximum value of 56, the excess portion is converted and added to the L dot expected value this time.

$$Cm\_new = 56$$

$$Cm\_over = Cm\_new0 - Cm\_new = 40$$

$$Cl\_new = C l + Cm\_over \times m 2 l = 0 + 40 \times 0.4 = 16$$

In this manner, converting into new large, medium, and small dot expected values is carried out. Afterwards, it is sufficient to perform the halftone process using the new expected values of the large, medium, and small dots.

In the present modified example, the small dot maximum value and the medium dot maximum value are determined by the same tetrahedral interpolation as used to determine the ink amount data, but stringency is not necessary for the small dot maximum value and the medium dot maximum value as for the ink amount data. Accordingly, in the method as shown in the third embodiment, determining may be carried out without using the interpolation calculating by performing assigning to appropriate grid points in the vicinity.

### Modified Example 4

In the embodiments described above, when performing the gradation number converting, a blue noise mask with similar error diffusion and characteristics was used as the dither mask DM, but a dot dispersion ordered dither which has a regular pattern such as a Bayer dither may be used. In addition, a dot cluster dither such as a halftone dither or a green noise mask may be used. In addition, ON/OFF of the dots may be determined by applying different dither masks for each dot of each of the color inks without adopting the concept of the continuous dither.

### Modified Example 5

In the embodiments described above, the large, medium, and small tables and the like are assigned to each of the grid points, but it is not always necessary to assign the large, medium, and small tables and the like to all of the grid points. For example, since problems such as the generating of irregularities do not occur in the regions with high brightness where dots are hardly formed, the large, medium, and small tables may be fixed (default tables). In detail, in a case where, for example, R>200/256, G>200/256, and B>200/256 is satisfied, it is sufficient to determine forming of each of the dots using the large, medium, and small tables prepared by default without referring to a 3D-LUT. The original range of the gradation values may be different for each of RGB. In addition, it is sufficient if the range of the appropriate gradation values is determined by experimentation or the like.

### Other Modified Examples

In the embodiments described above, the ink jet printer 22 which is a serial type of printer is used as the printing apparatus 10, but the printing apparatus 10 may be realized as another type of printer, for example, a page printer such as a line printer or a laser printer, or the like. In addition, the printing apparatus 10 may be realized as a printer for monochrome printing without being limited to a color printer. Furthermore, it is possible for the invention to be applied to various types of printer such as a thermal sublimation printer, a dot impact printer, or the like without being limited to ink jet printers.

In addition, the invention may also be applied to an image processing apparatus which only performs image processing. The processes which are exemplified in FIG. 4 and the like may be realized as a dedicated application program which is executed by a computer or may be carried out in a dedicated apparatus such as an RiP. Alternatively, the processes may be realized by an apparatus configuration which is able to print image data which is stored in a memory card or the like in the form of an independent printer such as a multi-functional device. In addition, it is not necessary to execute all of the image processes inside the printer driver and some of the processes may be executed on the printer side. Furthermore, a dedicated server which performs image processing in this manner may be placed in a network and may be operated in a format where the image data is processed according to a request from another computer or a printer.

In the embodiments described above, the printer 22 which is provided with a head which discharges ink using piezo elements PE as has already been described is used, but a printer which discharges ink using another method may be used. For example, the invention may be applied to a printer of a type where current is passed through a heater which is arranged in an ink passage and ink is discharged using bubbles which are generated inside the ink passage. Since it is possible to form dots with different dot diameters by changing the time during which current is passed through the heater and area where the current is passed, it is possible to apply the invention in such a printer.

In the embodiments described above, the processing is performed for each of the pixels but it is possible to perform the processing for a plurality of pixels, for example, units of 4 pixels which are 2×2. In this case, the processing is performed by determining the average of the gradation values of the plurality of pixels and the dots to be formed are determined for each pixel.

The invention is not limited to the embodiments and modified examples described above, and it is possible for the invention to be realized by various configurations within a scope which does not depart from the gist of the invention. For example, it is possible for the technical features in the embodiments and modified examples which correspond to the technical features in each of the forms described in the section of the Summary of the Invention to be appropriately replaced or combined in order to solve some or all of the problems described above or in order to achieve some or all of the effects described above. In addition, where the technical features are not described as essential in the present specification, it is possible to delete the technical features as appropriate.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing apparatus configured to print an image by forming dots of ink with a plurality of hues on a print medium, the printing apparatus comprising:
an input unit configured to input color image data for each of pixels which configures the image;
a color converting section configured to convert colors of the color image data which has been input into ink amount data on the plurality of hues for each of the pixels;
a head configured to form dots in a plurality of types for at least one of inks with hues out of the plurality of hues;
a gradation number converting processing section configured to convert the ink amount data which has been set into an expected value for forming each of the dots for each of the inks with the hues and generate dot data which represents whether or not each of the dots is formed for each of the pixels based on the expected value which has been converted; and
a printing section configured to drive the head in accordance with the dot data which has been generated and perform printing by forming the dots on the print medium,
the gradation number converting processing section including a dot converting section configured to perform converting, where the expected value for forming of dots in the plurality of types is determined from the ink amount data, according to the color image data in at least a portion of the color image data for at least one of the inks with the hues to form dots in the plurality of types.

2. The printing apparatus according to claim 1, wherein
the dot converting section performs selecting of a conversion parameter based on the color image data and performs the converting using the conversion parameter which has been selected.

3. The printing apparatus according to claim 2, wherein
the color image data is expressed as RGB data which is digital data in an RGB format or as CMYK data which is digital data in a CMYK format, and
the dot converting section performs the selecting according to a combination of the RGB data or a combination of the CMYK data.

4. The printing apparatus according to claim 1, wherein
the conversion parameter is prepared as a conversion table, and the dot converting section performs selecting of the conversion table based on the color image data and performs the converting using the conversion table which has been selected.

5. The printing apparatus according to claim 2, wherein
the conversion parameter is assigned to at least a portion of grid points in an N (where N is an integer of two or more) dimensional look up table where points, where gradation values of N colors which configure the color image data are appropriately combined, are set as the grid points, and
the dot converting section performs the converting by acquiring the conversion parameter which has been assigned to the grid points which correspond to the color image data during converting of dots.

6. The printing apparatus according to claim 5, wherein
the dot converting section performs the converting using a default conversion parameter for grid points where the conversion parameter has not been assigned.

7. The printing apparatus according to claim 5, wherein
the ink amount data on the plurality of hues is assigned to each of the grid points in the N dimensional look up table, and
the color converting section performs the converting of colors by referring to the grid points according to the color image data during the converting of colors.

8. The printing apparatus according to claim 5, wherein
the dot converting section performs the converting by stochastically selecting any one of grid points in a vicinity of the color image data during the converting of dots and acquiring the conversion parameter when the color image data is a value between the plurality of grid points.

9. The printing apparatus according to claim 2, wherein
the conversion parameter includes information about whether the conversion parameter is to be applied to any of the inks with the plurality of hues.

10. The printing apparatus according to claim 1, wherein
the inks with the plurality of hues include inks of cyan, magenta, and yellow, and
the dot converting section performs the converting for any of the inks of cyan, magenta, or yellow.

11. The printing apparatus according to claim 1, wherein
the dots in the plurality of types are dots where concentration per unit of area on the print medium is different.

12. A method for printing an image by forming dots of inks with a plurality of hues on a print medium using a head which is configured to form dots in a plurality of types for at least one of the inks with the hues out of the inks with the hues, the method comprising:
inputting color image data for each of pixels which configures the image;
converting colors of the color image data which has been input into ink amount data on the plurality of hues for each of the pixels;
performing converting, where an expected value for forming each of the dots is determined from the ink amount data, according to the color image data in at least a portion of the color image data for at least one ink with a hue to form dots in the plurality of types when a halftone process which generates dot data, which represents whether or not dots are formed for each pixel based on the ink amount data, is performed for each of the inks with the hues;
generating dot data which represents whether or not the dots in the plurality of types are formed based on the expected value which has been converted; and
forming the dots on the print medium by driving the head in accordance with the dot data which has been generated.

13. An image processing apparatus configured to process an image in order to form dots of ink with a plurality of hues on a print medium, the image processing apparatus comprising:
an input unit configured to input color image data for each of pixels which configures the image;
a color converting section configured to convert colors of the color image data which has been input into ink amount data on the plurality of hues for each of the pixels;
a gradation number converting processing section configured to convert the ink amount data which has been set into an expected value for forming each of the dots for each of inks with the hues, and generate dot data for dots in a plurality of types, which is dot data which represents whether or not each of the dots is formed for each of the pixels based on the expected value which has been converted, for at least one of the ink with the hues out of the plurality of hues,
the gradation number converting processing section including a dot converting section configured to perform converting, where the expected value for forming of dots in the plurality of types is determined from the ink amount data, according to the color image data in at least a portion of the color image data for at least one of the inks with hues to form dots in the plurality of types.

14. A program which uses a computer to realize a method where an image is printed by controlling a head which is configured to form dots in a plurality of types and forming dots of ink with a plurality of hues on a print medium for at least one of inks with hues out of a plurality of inks with hues, the program comprising:
inputting color image data for each of pixels which configures the image;
converting colors of the color image data which has been input into ink amount data in the plurality of hues for each of the pixels;
performing converting, where an expected value for forming each of the dots is determined from the ink amount data, according to the color image data in at least a portion of the color image data for at least one ink with a hue to form dots in the plurality of types when a halftone process, where dot data which represents whether or not dots are formed for each pixel is generated based on the ink amount data, is performed for each of the inks with the hues;
generating dot data which represents whether or not the dots in the plurality of types are formed based on the expected value which has been converted; and
forming the dots on the print medium by driving the head in accordance with the dot data which has been generated.
